(19) United States
(12) Patent Application Publication
(10) Pub. No.: US 2019/0251722 A1
(43) Pub. Date: Aug. 15, 2019

(54) SYSTEMS AND METHODS FOR AUTHORIZED EXPORTATION OF VIRTUAL CONTENT TO AN AUGMENTED REALITY DEVICE

(71) Applicant: Tsunami VR, Inc., Del Mar, CA (US)

(72) Inventors: David ROSS, San Diego, CA (US); Christopher RUSSELL, Alameda, CA (US); Kyle PENDERGRASS, San Diego, CA (US)

(21) Appl. No.: 16/270,840

(22) Filed: Feb. 8, 2019

Related U.S. Application Data
(60) Provisional application No. 62/628,872, filed on Feb. 9, 2018.

(51) Int. Cl. G06T 11/60

(52) U.S. Cl. CPC G06T 11/60

(57) ABSTRACT

Systems, methods, and computer-readable media for operating a virtual environment are provided. The method can include receiving information associated with a thing in view of an augmented reality (AR) device. The thing can be a physical object or a virtual element, such as text on a screen or a web page. The method can further include identifying the object or thing based on the information, identifying virtual content associated with the object or thing, determining that the AR device is permitted to receive at least a portion of the virtual content, transmitting the virtual content to the AR device based on the determining, and causing the AR device to display the virtual content. The ability of a user to view the virtual content associated with the object or thing can further be limited by an authentication process or access level.

### CROSS REFERENCE TO RELATED APPLICATIONS

This application claims priority to U.S. Provisional Patent Application Ser. No. 62/628,872, filed Feb. 9, 2018, entitled “SYSTEMS AND METHODS FOR AUTHORIZED EXPORTATION OF VIRTUAL CONTENT TO AN AUGMENTED REALITY DEVICE,” the contents of which are hereby incorporated by reference in their entirety.

### BACKGROUND

### Technical Field

This disclosure relates to virtual reality (VR), augmented reality (AR), and mixed reality (MR) technologies.

### Related Art

Mixed reality (MR), sometimes referred to as hybrid reality, is the term commonly applied to the merging of real or physical world and virtual worlds to produce new environments and visualizations where physical and digital objects co-exist and interact. Mixed reality visualizations and environments can exists in the physical world, the virtual world, and can include a mix of reality, VR, and AR via immersive technology including interactive environments and interactive three-dimensional (3D) virtual objects. Users of MR visualizations and environments can move around the MR visualizations and interact with virtual objects within the virtual environment.

Interactive 3D virtual objects can be complex and contain large amounts of information that describe different features of the virtual objects, including the geometry, appearance, scenery, and animation of the virtual objects. Particular features of a virtual object may include shape, surface geometry, color, texture, material type, light sources, cameras, peripheral objects, animation, physical properties, and kinematics.

MR, VR, and AR (or similar) devices can provide complex features and high-fidelity of representations of a physical world that can be useful in instruction or various types of training curricula or programs.

### SUMMARY

One aspect of the disclosure provides a method for operating a virtual environment. The method can include receiving, at one or more processors of a mixed reality platform, information associated with an object in view of an augmented reality (AR) device. The object can be a physical object located in a physical world or a virtual thing. The method can include identifying the object based on the information. The method can include identifying virtual content associated with the object. The virtual content can be stored in a database coupled to the one or more processors. The method can include determining that the AR device is permitted to receive at least a portion of the virtual content. The method can include transmitting the virtual content to the AR device based on the determining. The method can include causing the AR device to display the virtual content. The AR device can receive at least a portion the virtual content based on a permission level. The information can be collected by the AR device or received from the one or more processors based on the location of the AR device.

The information can be at least one of an image of the object captured at the AR device, a location of the object, and an image of a barcode of the object captured at the AR device.

The receiving can include receiving a wireless transmission from the object or thing.

The method can include performing a database query based on the information at the one or more processors.

The determining can be based on, for example, a white list including an identifier of the AR device, a user login credentials associated with a user of the AR device, and/or a biometric scan of a user associated with the AR device.

The virtual content can include an access level. The access level can include one of a public rating, a private rating, and a protected rating. The public rating permits any user to view the virtual content. The private rating permits certain users to view the virtual content. The protected rating permits only users having specific access rights to view the virtual content.

Another aspect of the disclosure provides a non-transitory computer-readable medium including instructions for operating a virtual environment. When executed by one or more processors, the instructions cause the one or more processors to receive information associated with an object in view of an augmented reality (AR) device. The object being a physical object located in a physical world. The instructions further cause the one or more processors to identify the object based on the information. The instructions further cause the one or more processors to identify virtual content associated with the object, the virtual content being stored in a database coupled to the one or more processors. The instructions further cause the one or more processors to determine that the AR device is permitted to receive at least a portion of the virtual content. The instructions further cause the one or more processors to transmit the virtual content to the AR device based on the determining. The instructions further cause the one or more processors to cause the AR device to display the virtual content.

### BRIEF DESCRIPTION OF THE DRAWINGS

The details of embodiments of the present disclosure, both as to their structure and operation, can be gleaned in part by study of the accompanying drawings, in which like reference numerals refer to like parts, and in which:

FIG. 1A is a functional block diagram of a system for creating computer-generated virtual environments and providing the virtual environments as an immersive experience for VR, AR and/or MR users;

FIG. 1B is a functional block diagram of user device for use with the system of FIG. 1;

FIG. 2 shows a method for authorized exportation of virtual content to an augmented reality device;

FIG. 3 is a flowchart of another embodiment of the method of FIG; and

FIG. 4 is a flowchart of another embodiment of the method of FIG. 2.

### DETAILED DESCRIPTION

This disclosure relates to different approaches for authorized exportation of virtual content to an augmented reality device.

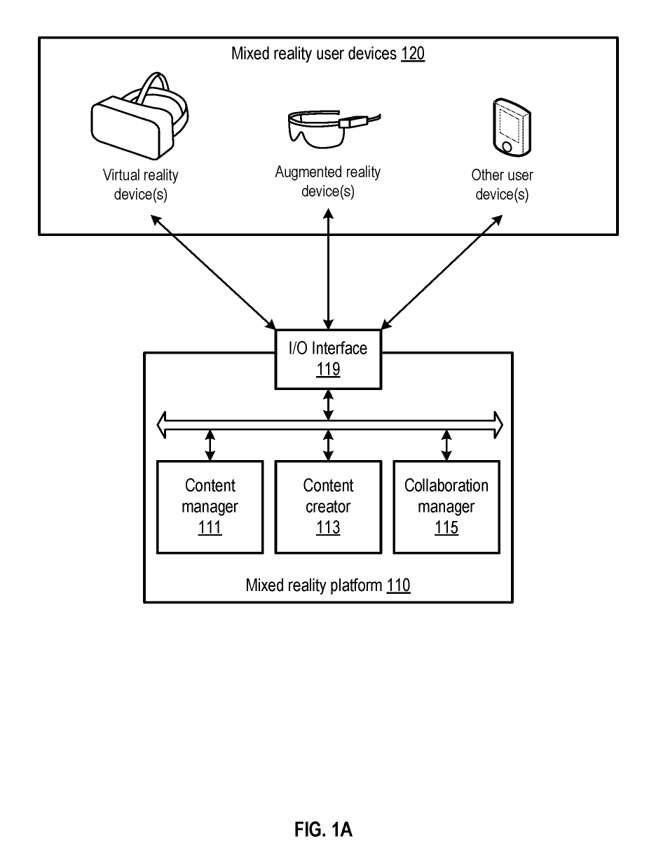

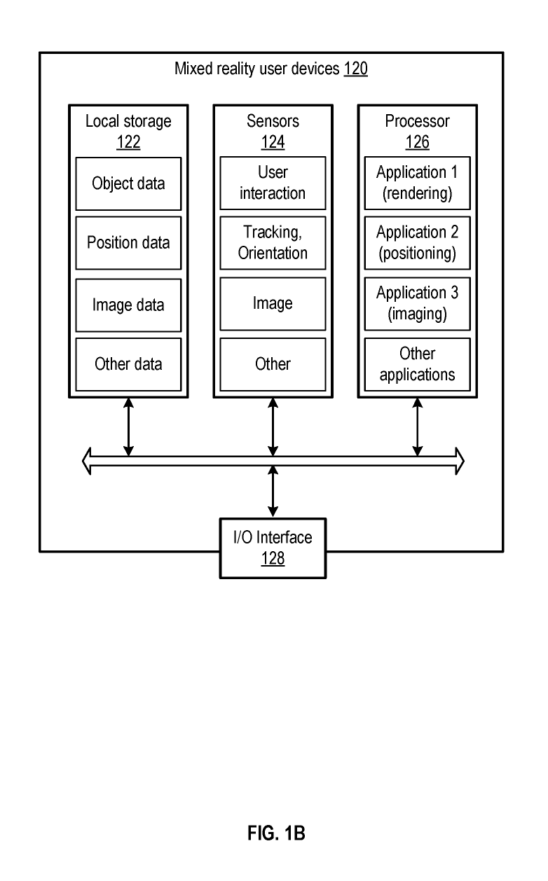

FIG. 1A is a functional block diagram of system for creating computer-generated virtual environments and providing the virtual environments as an immersive experience for VR, AR and/or MR users. Embodiments of the system depicted in FIG. 1A include a system on which different embodiments are implemented for authorized exportation of virtual content to an augmented reality device. The system includes a mixed reality platform 110 that is communicatively coupled to any number of mixed reality user devices 120 such that data can be transferred between them as required for implementing the functionality described in this disclosure. General functional details about the platform 110 and the user devices 120 are discussed below before particular functions involving the platform 110 and the user devices 120 are discussed.

As shown in FIG. 1A, the platform 110 includes different architectural features, including a content manager 111, a content creator 113, a collaboration manager 115, and an input/output (I/O) interface 119. The content creator 113 creates a virtual environment, and also creates visual representations of things as virtual content (e.g., virtual objects, avatars, video, images, text, audio, or other presentable data) that can be displayed in a virtual environment depending on a user's point of view. Raw data may be received from any source, and then converted to virtual representations of that data (i.e., virtual content). Different versions of virtual content may also be created and modified using the content creator 113. The content manager 111 stores content (e.g., in a memory) created by the content creator 113, stores rules associated with the content, and also stores user information (e.g., permissions, device type, or other information). The collaboration manager 115 provides portions of a virtual environment and virtual content to each of the user devices 120 based on conditions, rules, poses (e.g., positions and orientations) of users in a virtual environment, interactions of users with virtual content, and other information. The I/O interface 119 provides secure transmissions between the platform 110 and each of the user devices 120.

FIG. 1B is a functional block diagram of user device for use with the system of FIG. 1. Each of the user devices 120 includes different architectural features, and may include the features shown in FIG. 1B, including a local storage 122, sensors 124, processor(s) 126, and an input/output interface 128. The local storage 122 stores content (e.g., in a memory) received from the platform 110, and information collected by the sensors 124. The processor 126 runs different applications needed to display any virtual content or virtual environment to a user operating a user device. Such applications include rendering, tracking, positioning, 2D and 3D imaging, and other functions. The I/O interface 128 from each user device 120 manages transmissions between that user device 120 and the platform 110. The sensors 124 may include inertial sensors that sense movement and orientation (e.g., gyros, accelerometers and others), optical sensors used to track movement and orientation, location sensors that determine position in a physical environment, depth sensors, cameras or other optical sensors that capture images of the physical environment or user gestures, audio sensors that capture sound, and/or other known sensor(s). Depending on implementation, the components shown in the user devices 120 can be distributed across different devices (e.g., a worn or held peripheral separate from a processor running a client application that is communicatively coupled to the peripheral). Examples of user devices 120 include head-mounted displays, AR glasses, smart phones and other computing devices capable of displaying virtual content, and other suitable devices. By way of example, AR devices may include glasses, goggles, a smart phone, or other computing devices capable of projecting virtual content on a display of the device so the virtual content appears to be located in a physical space that is in view of a user.

Some of the sensors 124 (e.g., inertial, optical, and location sensors) are used to track the pose (e.g., position and orientation) of a user in virtual environments and physical environments. Tracking of user position and orientation (e.g., of a user head or eyes) is commonly used to determine fields of view, and each field of view is used to determine what virtual content is to be rendered using the processor 126 for presentation to the user on a display of a user device. Tracking the positions and orientations of the user or any user input device (e.g., a handheld device) may also be used to determine interactions with virtual content. In some embodiments, an interaction with virtual content (e.g., a virtual object) includes a modification (e.g., change color or other) to the virtual content that is permitted after a tracked position of the user or user input device intersects with a point of the virtual content in a geospatial map of a virtual environment, and after a user-initiated command is provided to make the desired modification. Positions in a physical environment may be tracked in different ways, including positioning using Global Navigation Satellite Systems (GNSS), Bluetooth, WiFi, an altimeter, or any other known way to estimate the position of a thing (e.g., a user or object) in a physical environment.

Some of the sensors 124 (e.g., cameras and other optical sensors of AR devices) may also be used to capture information about a physical environment, which is used to generate virtual representations of that information, or to generate geospatial maps of the physical environment that can be used to determine where and how to present virtual content among physical objects of the physical environment. Such virtual representations and geospatial maps may be created using any known approach. In one approach, many two-dimensional images are captured by a camera of an AR device, those two-dimensional images are used to identify three-dimensional points in the physical environment, and the three-dimensional points are used to determine relative positions, relative spacing and structural characteristics (e.g., surfaces and depths) of physical objects in the physical environment. Other optical sensors may be used in addition to a camera (e.g., a depth sensor). Textures, colors and other features of physical objects or physical environments can be determined by analysis of individual images.

Some of the sensors 124 (e.g., cameras and other optical and biometric sensors of the AR devices) may be used to capture biometric information (e.g. eye color, hair color, facial features, heart rate, etc.) about the wearer or user of the AR device (e.g., the user device 120). The captured information may assist the system in verifying the identity of the user. The captured biometric data can be used to, for example, authenticate the user. In other examples, the capture biometric data can be used in conjunction with additional authenticating elements such as a username and password (e.g., login credentials). Thus, the platform 110 can use captured biometric data to validate the user's identity.

Examples of the user devices 120 include VR, AR, MR and general computing devices with displays, including head-mounted displays, sensor-packed wearable devices with a display (e.g., glasses), mobile phones, tablets, desktop computers, laptop computers, or other computing devices that are suitable for carrying out the functionality described in this disclosure.

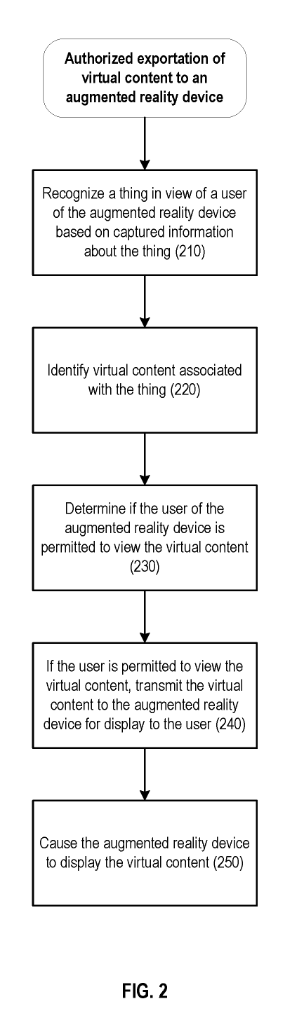

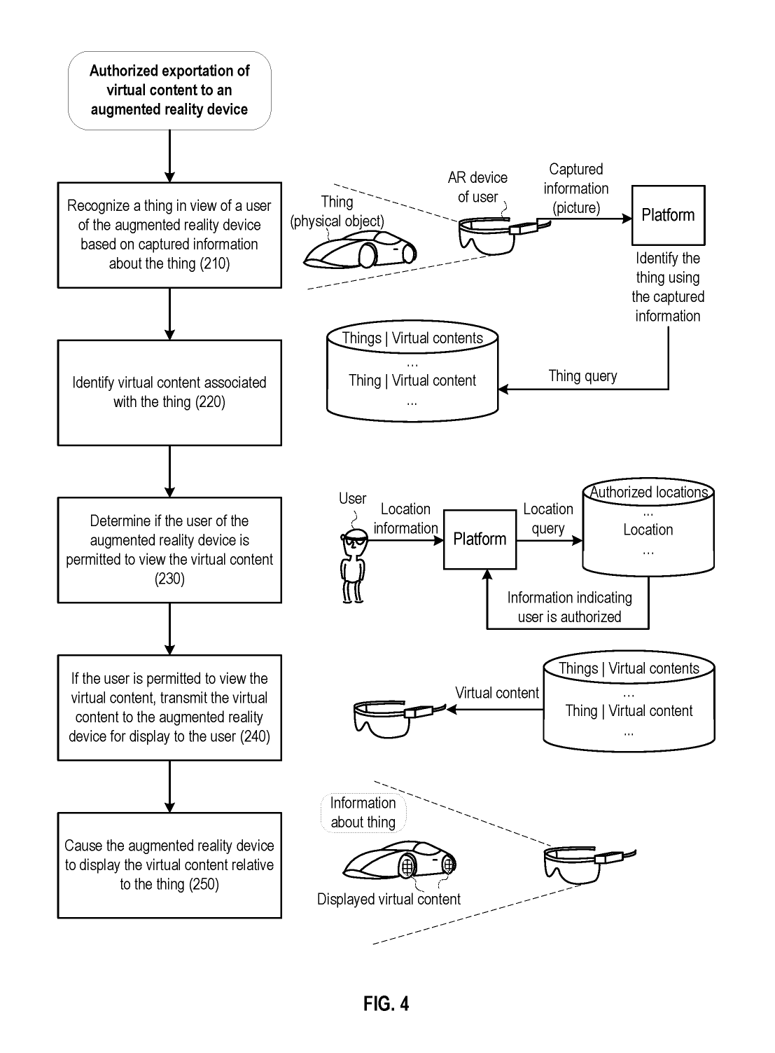

The methods or processes outlined and described herein and particularly those that follow below in connection with FIG. 2 and FIG. 4, can be performed by one or more processors of the platform 110 either alone or in connection or cooperation with the user device(s) 120. The processes can also be performed using distributed or cloud-based computing.

### Authorized Exportation of Virtual Content to an Augmented Reality Device

FIG. 2 is a flowchart of a method for authorized exportation of virtual content to an augmented reality device.

As shown in FIG. 2, a thing (e.g., object, webpage, image, etc.) in view of a user of the augmented reality device is recognized based on captured information about the thing (210). As used herein, a thing can be an entity or object of interest to a user. The user may be interested in the object (thing) based on a need or desire to have more information about the object (thing) in order to perform a job function, advance knowledge, or peak interest. A “thing” can include any physical object or entity in the physical world viewed by the AR user device 120. A thing can further include objects, entities, users, etc. that can be represented in a virtual world or a virtual space. Things may take on different forms, including: a physical object (e.g., a car), an image or text presented on a webpage or a physical material (e.g., a picture of a physical object, artwork, or others), or another type of thing.

For example, a user wearing an AR headset as part of his job function encounters various pieces of equipment while walking across the job site. The system (e.g., the platform 110) can identify the user as an employee responsible for performing specific job functions on specific pieces of equipment. The system can provide the user with only the content relative to equipment the user needs to interact with in order to perform a specified job function. In another example, a user wearing an AR headset is touring an oil refinery. The user is a potential customer of the oil refinery. Based on the fact that the user is not an employee of the oil refinery, the system may limit the content the user can view about the equipment the user encounters during his tour of the oil refinery and only provide content that is marked for public consumption.

The augmented reality device can use the camera, WiFi, BT, GPS, and various other sensors (e.g., the sensors 124) to capture information about the thing. In some examples, the sensors can capture/detect/reveal a number of characteristics of the thing. The relative location of the thing in relation to the AR user device GPS location can be used to determine a position of the thing, or about the location in which the thing is found. A camera can capture information about the physical characteristics of the thing (e.g., size, shape, color, etc.). Image capture can further scan a bar code or QR code, for example to determine other characteristics of the thing that are not readily identifiable by viewing the thing. Other sensors 124 can scan the thing or receive data transmitted from the thing or from sensors in the same area as the thing. Recognition of a thing in the vicinity of the user can be accomplished by different approaches. In one embodiment of step 210, an image of the thing is captured by a camera of the augmented reality device, and known image recognition software is used to identify the thing.

The system can use multiple methods to identify the thing. For example, the system can use a scan of a bar code or QR Code to identify the thing. In another example, the system can use sensor data collected by the AR headset. If the sensor data contains a unique identifier for the thing, the system can use that to identify the thing. In another example the system can use image recognition techniques to identify the thing. In this example, the AR headset captures one or more images of the thing and uses those images to uniquely identify the thing. In another example the system can use a combination of techniques to identify the thing. In this example the system narrows down the list of possible things by eliminating all the things that would not be found at the user's location. Next, the system can use sensor data collected by the AR headset to create a list of potential things based on the analyzing the data received from the sensors (e.g. things that transmit temperature readings). In another step the system can use one or more images captured by the AR headset to compare to the list of potential things.

In embodiments of step 210, the user identifies the thing (e.g., by selection, comparison of the thing to known objects in that location). In embodiments of step 210, an identifier of the thing is detected by the augmented reality device (e.g., a sensor of the augmented reality device scans a code identifier, a sensor of the augmented reality device detects an identifier emitted by the thing), and the identifier is used to identify the thing. In embodiments, the user selects an image of the thing on a display of the augmented reality device. In some examples, a scan can involve a database lookup (e.g., at the platform 110) which can occur via a server query or by a local lookup at the user device 120. In other examples, sensors of a thing or object or the thing or object itself can transmit an identifier that the user device 120 can reference in a server or memory query to determine what the object/thing actually is. Other approaches are also possible for recognizing a thing.

Virtual content associated with the thing is identified (220). Virtual content may take on different forms, including: a virtual representation of the thing; a virtual representation of the type of thing with modifiable features (e.g., a virtual representation of a purchasable thing like a car with an option to change the color or other features of that virtually represented thing); information about the thing (e.g., cost, reviews, maintenance records, operational procedures, background information); or other content. The virtual content may include both public, private and protected information about the thing. The public information can be provided to any user. Private information may be accessible by a select or otherwise limited list of users or user devices 120 (e.g., a white list or black list). Protected information may be viewed by one or more users or user devices having specific access rights. The system (e.g., the platform 110) can implement multiple methods of verifying access rights (e.g., authentication) for protected information prior to allowing the user or user device 120 to access/view/modify the protected information, as described below. The thing itself may not be purchasable, and can be anything (e.g., a physical object that is maintained, repaired or operated, or another type of thing).

A determination is made as to whether the user of the augmented reality device is permitted to view the virtual content (230). In some embodiments of step 230, user information is checked against an authorized list of users (e.g., the user logs into an authorized user account or is compared to for example, a white list or a black list), and the user is permitted to view (e.g., at least a portion of) the virtual content if the user is authorized. In another embodiment of step 230, a determination is made as to whether the location of the augmented reality device is within a predefined distance or area relative to the thing. The location can be determined by GPS, WiFi, BT, or other well-known methods to determine location information. Location information can also be gleaned by determining whether the augmented reality device is receiving data from a sensor associated with the thing. For example, sensor data can be transmitted over a short distance and therefore if the AR device is receiving the sensor data the system can assume the user is within close proximity to the thing. The system determines if the user is permitted to view virtual content associated with the thing, for example, if the location of the augmented reality device is within the predefined distance or area relative to the thing.

In other embodiments of step 230, the system (e.g., the platform 110) can confirm user access or authorization rights. The access rights or authorization rights determine the type or amount of virtual content available to the user (e.g., the user device 120). Each element or piece of virtual content can be classified by an access rating, for example public, private, or protected as noted above. For example, the public rating allows any user to view the content, the private rating allows only the or specific users (e.g., on a whitelist or not on a black list) to view the content, and the protected rating requires the user to have specific access rights to view the content. In some instances, a white list may identify specific users exactly (e.g., a list of names or other identifiers) whereas specific access rights identify a class of users, users with a given security clearance level, or users with a specific title. Specific access rights can include, for example, credentials (e.g., username and password), a security clearance or rating, a specific title or job description, or other distinguishing characteristics. The access rights can further include, for example, classification level, status, user title, user job description or function, proximity to the thing, an identity of the user, identifier of the user device, or a combination of the foregoing.

In some examples, difference versions of virtual content may be presented, based on the user access rights or authorization levels. For example, a public version of the virtual content may be widely accessible. On the other hand, the private or protected versions of the content contain data that could be used to create a competitive advantage, cause harm, expose, or in some way negatively impact the owner of the virtual content and therefore should be protected.

If the user is permitted to view the virtual content, the virtual content is transmitted to the augmented reality device for display to the user (240). In some embodiments, at least a portion of the virtual content is transmitted to the AR device, based on the permissions or authorization level(s).

The augmented reality device is caused to present (e.g., display, play) the virtual content (250). Examples of displaying the virtual content include: overlaying the virtual content over the thing; displaying the virtual content at a preset position relative to a predefined point on the thing; displaying the virtual content in view of the user and letting the user move the virtual content to a location in a physical space; or another way of displaying. In one embodiment of step 250, the augmented reality device is caused to display the virtual content when executable instructions are received by the augmented reality device from the platform, wherein the instructions direct the augmented reality device to display the virtual content.

FIG. 4 is a flowchart of another embodiment of the method of FIG. 2. As shown in relation to step 210, the thing can be recognized by capturing one or more details about the thing. For example, the thing could be an image of a chair (as shown) and the platform 110 can recognize and thus identify the chair based on the image recognition software algorithms. The user of the AR user device 120 would also recognize the chair from simply viewing it within the AR display. In some examples, image recognition can be performed at the platform 110 given software and processing limits of the user device 120. For example, such image recognition may require computationally intensive processes or complex database searches that are too large to store and/or search on the user device 120.

In step 220, the platform 110 can identify the thing as the chair based on a query of an associated database, to identify the chair. The database can have one or more memories or memory storage devices communicatively coupled to the platform 110.

In step 230, the platform can conduct a search (e.g., in response to a user query for information about the thing) within known or authorized users in a memory, for example. The user can be an authorized user if the user has, for example, a current account or other applicable credentials. If the user identity properly referenced in the memory, then the user can be identified as authorized. In another example, if the user is identified on a white list, the user may be authorized. Alternatively, if the user is identified on a black list, the user may not be authorized.

In step 240, the platform 110 can provide requested or applicable virtual content associated with the thing (e.g., the chair of step 210).

In step 250, the AR user device 120 can display the virtual content associated with the thing (to the user).

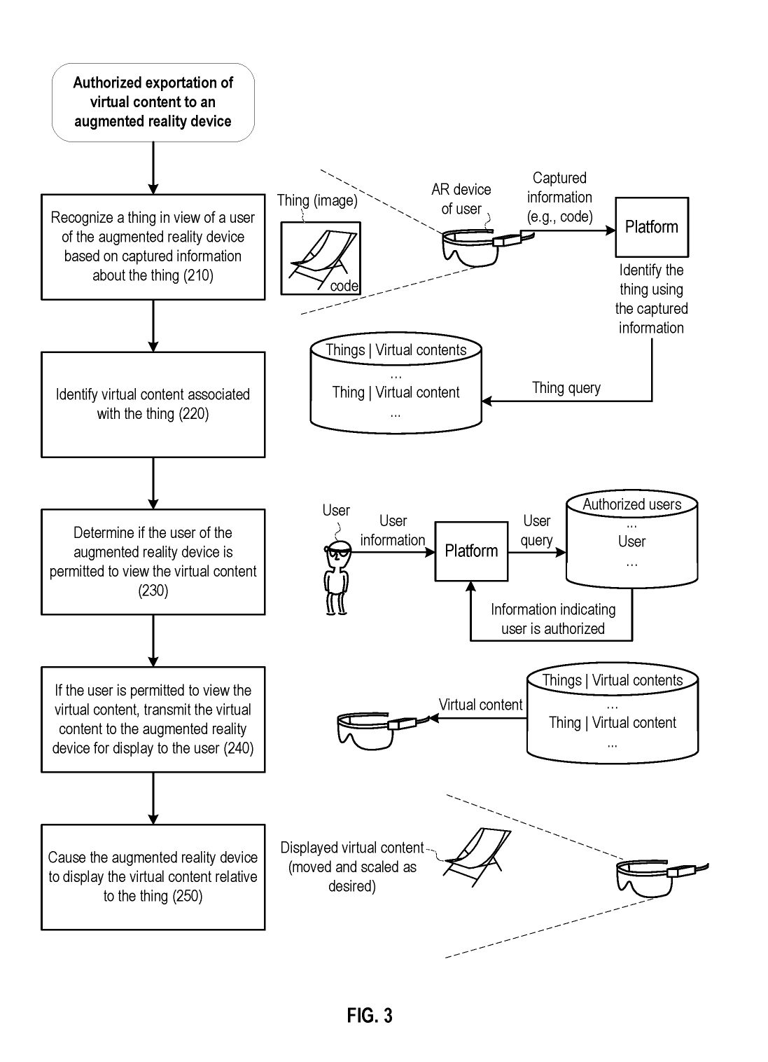

FIG. 4 is a flowchart of another embodiment of the method of FIG. 2. The steps of FIG. 4 are similar to those described above in connection with FIG. 3, except that instead of an image of a chair, the thing is a physical object, such as a car.

### Technical Solutions to Technical Problems

Methods of this disclosure offer different technical solutions to important technical problems.

One technical problem is providing secure access to sensitive data by a particular user device 120. Solutions described herein provide secure access to data and permit only certain user devices to receive desired virtual content (e.g., from the platform 110) while excluding other user devices from accessing the virtual content.

Another technical problem is delivering different content to different users, where the content delivered to each user is more relevant to that user. Solutions described herein provide improved delivery of relevant virtual content, which improves the relationship between users and sources of virtual content, and provides new revenue opportunities for sources of virtual content.

### Other Aspects

Each method of this disclosure can be used with virtual reality (VR), augmented reality (AR), and/or mixed reality (MR) technologies. Virtual environments and virtual content may be presented using VR technologies, AR technologies, and/or MR technologies.

Methods of this disclosure may be implemented by hardware, firmware or software. One or more non-transitory machine-readable media embodying program instructions that, when executed by one or more machines, cause the one or more machines to perform or implement operations comprising the steps of any of the methods or operations described herein are contemplated. As used herein, machine-readable media includes all forms of machine-readable media (e.g. non-volatile or volatile storage media, removable or non-removable media, integrated circuit media, magnetic storage media, optical storage media, or any other storage media) that may be patented under the laws of the jurisdiction in which this application is filed, but does not include machine-readable media that cannot be patented under the laws of the jurisdiction in which this application is filed.

By way of example, machines may include one or more computing device(s), processor(s), controller(s), integrated circuit(s), chip(s), system(s) on a chip, server(s), programmable logic device(s), other circuitry, and/or other suitable means described herein (e.g., the platform 110, the user device 120) or otherwise known in the art. Systems that include one or more machines or the one or more non-transitory machine-readable media embodying program instructions that, when executed by the one or more machines, cause the one or more machines to perform or implement operations comprising the steps of any methods described herein are also contemplated.

Method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency. Method steps can be performed at any of the system components shown in the figures.

Systems comprising one or more modules that perform, are operable to perform, or adapted to perform different method steps/stages disclosed herein are also contemplated, where the modules are implemented using one or more machines listed herein or other suitable hardware. When two things (e.g., modules or other features) are “coupled to” each other, those two things may be directly connected together, or separated by one or more intervening things. Where no lines and intervening things connect two particular things, coupling of those things is contemplated in at least one embodiment unless otherwise stated. Where an output of one thing and an input of another thing are coupled to each other, information sent from the output is received by the input even if the data passes through one or more intermediate things. Different communication pathways and protocols may be used to transmit information disclosed herein. Information like data, instructions, commands, signals, bits, symbols, and chips and the like may be represented by voltages, currents, electromagnetic waves, magnetic fields or particles, or optical fields or particles.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics of each of the described embodiments may be readily combined in any suitable manner in one or more embodiments.

What is claimed is:

1. A method for operating a virtual environment comprising:
receiving, at one or more processors of a mixed reality platform, information associated with an object in proximity to an augmented reality (AR) device, the object being a physical object located in a physical world;
identifying the object based on the information;
identifying virtual content associated with the object, the virtual content being stored in a database coupled to the one or more processors;
determining that the AR device is permitted to receive at least a portion of the virtual content;
transmitting the virtual content to the AR device based on the determining; and
causing the AR device to display the virtual content.

2. The method of claim 1, wherein the AR device is permitted to receive at least a portion the virtual content based on a permission level.

3. The method of claim 1, wherein the information is collected by the AR device or received from the one or more processors based on the location of the AR device.

4. The method of claim 1, wherein the information comprises at least one of:
an image of the object captured at the AR device;
a location of the object;
an image of a barcode of the object captured at the AR device.

5. The method of claim 1, wherein the receiving comprises receiving a wireless transmission from the object, the object having a wireless transmitter.

6. The method of claim 1 further comprising performing a database query based on the information at the one or more processors.

7. The method of claim 1, wherein the determining is based on a white list including an identifier of the AR device.

8. The method of claim 1, wherein the determining is based on a user login credentials associated with a user of the AR device.

9. The method of claim 1, wherein the determining is based on a biometric scan of a user associated with the AR device.

10. The method of claim 1, wherein virtual content is associated with an access level, the access level being one of a public rating, a private rating, and a protected rating,
wherein the public rating permits any user to view the virtual content,
wherein the private rating permits certain users to view the virtual content, and
wherein the protected rating permits only users having specific access rights to view the virtual content.

11. A non-transitory computer-readable medium for operating a virtual environment comprising instructions that when executed by one or more processors, cause the one or more processors to:
receive information associated with an object in view of an augmented reality (AR) device, the object being a physical object located in a physical world;
identify the object based on the information;
identify virtual content associated with the object, the virtual content being stored in a database coupled to the one or more processors;
determine that the AR device is permitted to receive at least a portion of the virtual content;
transmit the virtual content to the AR device based on the determining; and
cause the AR device to display the virtual content.

12. The non-transitory computer-readable medium of claim 11, wherein the AR device is permitted to receive at least a portion the virtual content based on a permission level.

13. The non-transitory computer-readable medium of claim 11, wherein the information is collected by the AR device or received from the one or more processors based on the location of the AR device.

14. The non-transitory computer-readable medium of claim 11, wherein the information comprises at least one of:
an image of the object captured at the AR device;
a location of the object;
an image of a barcode of the object captured at the AR device.

15. The non-transitory computer-readable medium of claim 11, wherein the receiving comprises receiving a wireless transmission from the object, the object having a wireless transmitter.

16. The non-transitory computer-readable medium of claim 11 further comprising instructions that cause the one or more processors to perform a database query based on the information at the one or more processors.

17. The non-transitory computer-readable medium of claim 11, wherein the determining is based on a white list including an identifier of the AR device.

18. The non-transitory computer-readable medium of claim 11, wherein the determining is based on a user login credentials associated with a user of the AR device.

19. The non-transitory computer-readable medium of claim 11, wherein the determining is based on a biometric scan of a user associated with the AR device.

20. The non-transitory computer-readable medium of claim 11, wherein virtual content is associated with an access level, the access level being one of a public rating, a private rating, and a protected rating,
wherein the public rating permits any user to view the virtual content,
wherein the private rating permits certain users to view the virtual content, and
wherein the protected rating permits only users having specific access rights to view the virtual content.
